(19) United States
(12) Patent Application Publication
(10) Pub. No.: US 2002/0146667 A1
(43) Pub. Date: Oct. 10, 2002

(54) Staged-learning process and system for situational awareness training using integrated media

(75) Inventors: James C. Dowdell, Coraopolis, PA (US); Loren Staplin, Allentown, PA (US)

Correspondence Address: Gene A. Tabachnick, Esquire, REED SMITH LLP, P.O. BOX 488, PITTSBURGH, PA, 15230-0488, US

(73) Assignee: SAFE DRIVE TECHNOLOGIES, LLC

(21) Appl. No.: 10/076,911

(22) Filed: Feb. 14, 2002

Related U.S. Application Data
(60) Provisional application No. 60/269,206, filed on Feb. 14, 2001.

(51) Int. Cl. G09B 9/04; G09B 19/16

(52) U.S. Cl. 434/62

(57) ABSTRACT

A method and system is disclosed for a staged learning process for situational awareness training using integrated media wherein a mix of classroom lectures, computer-based training and immersive simulation is used to advance the student from an operational stage to a tactical stage to a strategic stage. During the simulation exercises, the student is presented with a realistic interactive driving environment and external stimuli. The simulator measures and records the student's performance, generating a score based on various factors. The student is then able to review his or her performance or parts thereof from multiple perspectives. The process teaches, tests and reinforces situational awareness in drivers through an orderly, consistent “preview, drive, review” procedure and gives the student a level of situational awareness generally achieved by a driver with greater experience.

### FIELD OF THE INVENTION

The present invention relates generally to a staged-learning process and system, and more particularly to a staged-learning process and system for situational awareness in the field of driver training.

### BACKGROUND OF THE INVENTION

Driving is a skilled behavior. A skilled driver demonstrates proficiency in two key areas: (1) vehicle operations and control and (2) driving knowledge, tactics and strategy. Learning how to operate and maneuver a vehicle is a critical first step in preparing a beginner to drive. Fortunately, most beginners quickly become accomplished in vehicle handling skills. When young drivers are injured or killed in crashes, some error that reflects a lack of tactical or strategic knowledge about a driving situation is commonly the cause. As recognized by the growing number of graduated licensing programs for novice drivers throughout the United States, the need for a program of instruction in how to recognize and respond to the safety threats encountered in diverse driving situations is paramount.

When driving, individuals are constantly bombarded by sources of information from the environment. The view of the road on which the individual is traveling, the sight of traffic lights and road signs, the readings on the instrument panel, the output of a radio, the temperature inside and outside the vehicle, the sound of the engine, the noise of other cars and pedestrians, conversation within the vehicle, and so forth, all contribute to the barrage of information that the driver must process and evaluate while operating the vehicle. Such information sources do not even include unexpected occurrences such as another vehicle suddenly stopping, changing lanes or turning, pedestrians or animals stepping out in front of moving vehicles, and unnoticed road hazards (e.g., slick or icy patches on the road). In order to operate the vehicle safely and to successfully negotiate both common driving situations and unexpected hazards, the driver must have a sufficient level of situational awareness to understand the current circumstances, anticipate hazards that lie ahead and react accordingly. Generally, most licensed drivers possess what would be considered minimally acceptable levels of situational awareness, while beginning drivers generally fall short of these levels. Even the most experienced drivers, such as the elderly, can demonstrate a deficit in situational awareness that leads to increased risk of a crash, though usually for different reasons than the young, novice driver.

Historically, driver training consists simply of a minimal number of hours in a classroom learning the “rules of the road” and the basic operations of an automobile, followed by a few hours of practical instruction behind the wheel of an actual automobile, and nothing further. With such methods it is difficult, if not impossible, for a student to encounter a variety of real-world situations and to learn how to respond tactically and strategically to such situations in a safe, controlled (yet realistic) environment. It is also difficult for the student to receive meaningful review and feedback of his or her performance behind the wheel. An instructor may give piecemeal feedback as the student is driving, but a comprehensive review and analysis of the student's performance after-the-fact, allowing the student to review his or her performance from different perspectives, is more difficult. It would be desirable, therefore, given present trends in teenage traffic fatalities, to improve and enhance such methods so that students can experience a wider variety of real-world situations, learn how to respond properly and safely to those situations, and receive meaningful feedback to develop a higher level of situational awareness.

The present invention proposes to overcome the limitations in the prior art by utilizing a staged learning model that incorporates state-of-the-art simulation media. The staged learning model, which draws upon well-established cognitive-developmental principles taught in most graduate psychology programs in the United States, is applied to link skill-building at an operational level, starting with the most basic vehicle maneuvers, to the acquisition of more tactical and strategic aspects of safe driving which characterize the experienced operator. Simulation in this application may include visualization via computer-based training on a desktop, as well as fully interactive graphics on a wide angle display that respond to conventional brake, accelerator, and pedal inputs by the student in an actual vehicle cockpit. Key attributes of simulation in this model include the realistic context-specific nature of stimuli presented to a student, the high-resolution image and absence of noticeable perceptual lag in system response to control input, and the reinforcement of appropriate responses to those stimuli through immediate feedback.

Learning to drive begins as a novice develops a sense of the space a vehicle occupies, how it responds to control inputs, and how its size and motion must be managed in relation to fixed features of the driving environment. With mastery of these early concepts, learning at an operational stage becomes feasible, where a sequence of planned movements is carried out to achieve a behavioral goal. The student's progress at this point is marked by competent performance of basic vehicle maneuvers, absent traffic conflicts. It is suggested that simulation assumes prominence among competing methods of instruction at this stage. Essential benefits include visual and force feedback in response to control inputs, which allow the student's behavior to be shaped in the simulator through successive approximations while the compressed time-frame increases the efficiency of the learning process. The steps in the evolution of driver situational awareness, which relate to concrete and formal operational stages in the cognitive-developmental model, are to a large degree enabled by the ability to assume a non-egocentric perspective. It is the ability to view an object or situation from different perspectives than one's own that is critical in understanding the perceptions and actions of others. This understanding, which provides a foundation for tactical decisions while driving, is normally gained through repeated exposures. Over time, all perspectives are experienced directly by the student and are then integrated into a mental construction that can be referenced to make decisions and plan actions. Using three-dimensional visualization techniques afforded through manipulation of computer graphics, both desktop and cockpit simulation platforms offer unique strengths to facilitate the student's construction of these key mental models underlying behavioral choice while driving. The retention of lessons learned en route to situational awareness by a driver depends strongly upon the depth of processing and subsequent rehearsal of the subject information. The ability of full-scale systems to elicit involuntary, visceral responses through realistic simulations of loss-of-control and collision events, even in the absence of full motion inputs, dramatically improves retention of safety concepts.

### SUMMARY OF THE INVENTION

The present application discloses a staged-learning process and integrated media for situational awareness training in the field of driver education. The operational stage preferably begins with computer-based training wherein the student initially learns the fundamentals of vehicle operations and traffic laws. Next, the student transitions to the tactical stage, wherein classroom lectures or additional computer or other technology-based training serves to review and reinforce the topics addressed during the operational stage and prepare the student for transition to the strategic stage. Finally, the student engages in behind-the-wheel training in an actual vehicle on an actual roadway.

During each stage, a state-of-the-art driving simulator may be utilized to present the student with a realistic interactive driving environment and external stimuli such as unexpected hazards and weather-related elements. The simulator uniquely facilitates transition from one stage to the next and allows the student to understand consequences of roadway choices and learn real-time vehicle control. The simulator may measure and record the student's performance, generating a score based on various factors. The student is then able to review his or her performance from multiple perspectives.

### BRIEF DESCRIPTION OF THE DRAWINGS

While the specification concludes with claims specifically pointing out and distinctly claiming the subject matter of the invention, it is believed the invention will be better understood from the following description taken in conjunction with the accompanying drawings wherein like reference characters designate the same or similar elements and wherein:

FIG. 1 illustrates a general block diagram of the various steps of the present invention and the components used in conjunction therewith.

### DETAILED DESCRIPTION OF THE PREFERRED EMBODIMENT

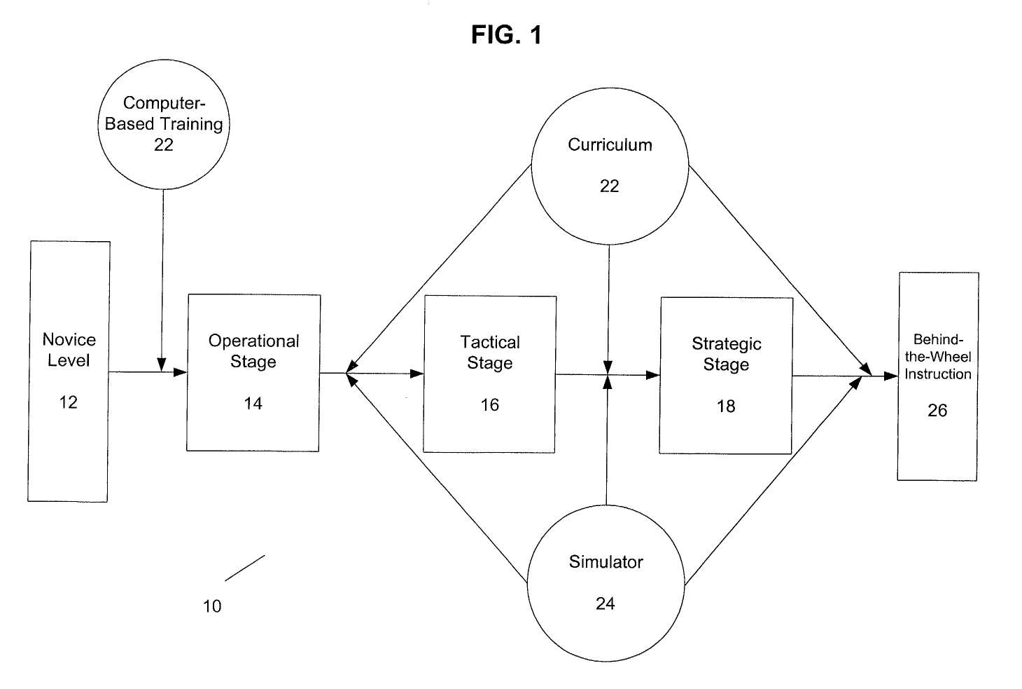

Referring to FIG. 1, a preferred training method 10 disclosed therein allows the student to progress orderly from a novice level 12 through three stages, namely the operational stage 14, the tactical stage 16 and the strategic stage 18. The operational stage 14 involves basic operations of the vehicle and fundamentals of traffic laws and road rules. The tactical stage 16 involves decisions that make it easier to get from place to place, such as whether to pass a truck going uphill or whether to pass a left-turning car on the right shoulder of the road. The strategic stage 18 involves a more abstract, higher understanding of the driving task, such as understanding that roads may be the most slick during the first few minutes of a rainfall and knowing how to deal safely and effectively with such situations.

The training method 10 disclosed in FIG. 1 begins with a transition from the novice level 12 to the operational stage 14, through the initial acquisition of knowledge of the fundamentals of driving, such as basic vehicle operations and rules of the road. This initial progression helps to ensure that the student has a thorough knowledge of the common features encountered on streets and highways, the devices used to control traffic, and the rules of their operation. In a preferred embodiment, the operational stage 14 utilizes computer-based training 20, which may be available through distributed media or accessed via the Internet, and which is used to develop a solid knowledge foundation as well as act as a preview to prepare the student for each successive topic and training goal addressed during the subsequent stages.

In one preferred embodiment, once the student has progressed through the operational stage 14, the next step is to review and reinforce the topics addressed during the operational stage 14 and begin the transitions to the tactical stage 16 and the strategic stage 18. In one preferred embodiment, curriculum 22 presented in these stages is divided into two components, namely a lecture component and a technology-based component. In another embodiment, curriculum 22 in these stages is entirely computer-based training. In these stages, the student moves beyond the fundamentals of driving and begins to learn advanced tactics through technology-enhanced situational awareness exercises. For example, in one preferred embodiment, these exercises may include showing the student a pre-recorded video from a driver's perspective and requiring the student to use a mouse or joystick to click on locations in the field of view where the student should be scanning or watching if he or she were in the position of the driver. Data may be collected and scoring standards developed so that the student's progress may be tracked with objective scores.

Curricula 22 may be selected and presented in any appropriate fashion that enables the student to transition from the operational stage 14 to the tactical stage 16 to the strategic stage 18. In a preferred embodiment, the curriculum is divided into an introductory level and an advanced level and is presented in multiple lessons over a period of time, where each lesson may take place in one class or over multiple classes.

For example, in one embodiment, a high school may present the curriculum in eighteen weekly classes or lessons, corresponding to an eighteen-week semester. In this embodiment, the introductory level preferably includes the following subject matter:

Build competence and confidence in the student's ability to navigate a guided path through environments of mixed type and level of development, select lane position and remain within lane boundaries as appropriate to each instructed maneuver.

Achieve a comfort level in maintaining effective control over speed, heading, and lateral lane position, traveling at lower speeds, during brief encounters with oncoming traffic and when passing isolated parked cars, pedestrians, and cyclists.

Achieve a comfort level in maintaining effective control over speed, heading, and lateral lane position, traveling at all speeds, during encounters with a steady stream of oncoming traffic and when passing numerous parked cars, pedestrians, and cyclists.

Demonstrate the student's knowledge of what messages are conveyed by the many signs, signals, and pavement markings encountered in everyday driving, on all types of roadways, and how to respond to them in a manner that minimizes conflicts with other road users.

Enable the student to continuously scan the driving scene ahead to identify features of the natural and built environment, as well as static and dynamic traffic elements, with the potential to affect the planned path of travel.

Develop the student's appreciation of traffic and environmental conditions 15-30 seconds ahead that may affect maneuver choice, while immediate vehicle control to maintain safe distance and to respond to safety threats immediately ahead remains unimpaired.

Familiarize the student with the variability in traffic operations and control, as well as the traffic conflicts present for through and turning movements at rural and suburban intersections; and to make appropriate speed and heading changes during the intersection approach.

Familiarize the student with the variability in traffic operations and control, as well as the traffic conflicts present for through and turning movements at urban intersections; and to make appropriate speed and heading changes during the intersection approach.

Provide competence in negotiating freeway acceleration lanes, deceleration lanes, and merging/weaving zones at interchanges, and to safely and smoothly perform lane change and passing maneuvers with a mix of passenger cars and trucks in the traffic stream.

After completion of the introductory level, the student proceeds to the advanced level, which enables the student to acquire or enhance tactical and strategic understanding of the driving task and preferably includes the following subject matter:

Give the student exposure and improve his or her knowledge of how to respond when wet pavement, rough or deteriorating pavement, uneven pavement, and drop-offs are encountered, plus roads and bridges where lanes are restricted or there is substandard design for roadside obstructions.

Expose the student to emergency vehicle and school bus operations; road construction, with lane closures in work zones; center lane, two-way left turn operations; highway-rail grade crossings; and to provide practice in recognizing the key decision elements in each situation.

Educate the student about the increased difficulty in lane keeping, path following, and hazard detection under rainy, snowy, and/or foggy conditions, and the consequences of the reduced time for decision making, response selection, and maneuver execution.

Give the student an appreciation of the limitations in detecting hazards in and near the roadway at night, the reduced time available to react when a hazard is encountered, and how driving behaviors can be adapted to improve safety and comfort during nighttime operation.

Demonstrate how the requirements to safely perform a wide range of vehicle maneuvers from, for example, simple path maintenance on a two-lane highway to the selection of gaps for turning at busy intersections, change for nighttime versus daytime driving.

Develop the ability to focus and sustain attention upon a hierarchy of speed management and headway maintenance tasks under high speed and/or high density driving conditions, while recognizing and responding to potential conflicts both in the immediate vicinity and far downstream.

Increase the likelihood that the student will anticipate possible violations and better respond when another driver runs a red light or a stop sign, changes lanes or stops ahead without warning, or signals an intention to perform one maneuver but behaves in a contradictory manner.

Illustrate the risks inherent in talking with passengers, tuning the radio, using a cell phone, and diverting attention to other in-vehicle and external distractions, as they delay recognition of traffic control devices and messages and impair ability to respond to unexpected safety threats.

Provide practice and build confidence in the student's ability to handle the workload experienced under reasonable worst-case conditions of normal driving, combining the challenges of poor visibility, complex geometries and traffic operations, distractions and violations of expectancy.

Depending on the time frame available to the instructor and on the ability of the student or students, the foregoing lessons may be expanded, contracted, combined or otherwise modified or tailored in any appropriate fashion to suit the instructor's and/or the student's needs and abilities.

Interspersed among the stages of the training method 10 is the use of a driving simulator 24, which uniquely facilitates transition from one stage to the next and allows the student to understand consequences of roadway choices and learn real-time vehicle control. By interspersing the simulator training among the stages, the foregoing lectures and/or technology-based training may be provided to the student both before and after each session in the driving simulator 24. Having a computer-based preview and review element associated with simulation sessions reinforces the information conveyed throughout each of the stages. It applies the knowledge elements graphically, using real-world driving situations to underscore key concepts, and it supports practice and assessment of many of the critical visual scanning abilities not feasible to isolate when driving in the simulator 24. And as discussed below, it also provides feedback on performance in the simulator that is individually-tailored to address specific problems and errors.

The driving simulator 24, which is an interactive system presenting computer-generated roadway environments and realistic traffic patterns, offers particular advantages for the training of safe driving habits.

Precise measures of a student's reaction to hazards—including threats that would be too risky to expose the novice to if actually driving—are possible in the simulator 24, allowing standardized, objective assessments of progress through the curriculum 22. The student's braking, accelerating and steering inputs, using normal controls in a simulated vehicle cockpit, define the core performance measures used as graduation criteria.

An example of a suitable driving simulator 24 is disclosed in U.S. Pat. No. 6,270,350, which is incorporated fully herein by reference. In addition to simulating an actual vehicle cockpit by incorporating a steering wheel, brake and accelerator, the simulator 24 includes a wide-angle display for displaying road and traffic images to the student. A program storage and playback device is accessed to display the appropriate video images. Such situations preferably include pedestrians stepping in front of the car, cyclists who share the road and are (at unpredictable intervals) in conflict with the car, other vehicles approaching from the side from alleys, driveways and other roadways, inanimate objects falling or moving in front of the car, stationary objects used for traffic control, such as stop signs, speed bumps and construction barriers and signs, and various types of weather-related elements. The different objects or obstacles that are introduced may vary in duration and location within the driving scene of the video images, and may vary in size, motion, resolution, brightness or contrast. Furthermore, the simulator 24 preferably responds not only to a student's input but also to internal pre-programmed factors such as weather-related elements (e.g., ice and rain) and road conditions (e.g., bumps and potholes). A predetermined number of such situations may be presented and tested, while the system records in its memory the reactions of the student.

The simulator 24 may be used during the operational stage 14 of novice instruction by having the student learn and practice basic early skills, thereby reinforcing and testing the basic driving skills learned during the initial computer-based training and during the classroom lectures.

The simulator 24 may be used during the tactical stage 16 and strategic stage 18 by having the student deal with special threats and risky situations, thereby reinforcing and testing the more advanced situational awareness lessons learned during the classroom lectures and technology-enhanced exercises.

During each simulation session, data is preferably collected concerning a number of factors, such as lane position, speed management and space management, and the student receives a score based thereon. For example, the data may show that the student kept the vehicle within the lane a certain percentage of the time. Each simulation is recorded from different angles so that the student may review his or her performance via computer after the simulation. Thus, the student can observe the performance from multiple perspectives to gain a better understanding of the situations that were presented during the simulations and his or her responses thereto and to better understand the meaning and significance of the student's scores. For example, if the student experienced difficulty keeping the vehicle between the lines on the road or followed the vehicle in front too closely, then the student can be shown an overhead view to better understand these issues.

Once the student completes the progression from operational stage 14 to tactical stage 16 to strategic stage 18, he or she, in one embodiment, returns to the classroom for preparation of the behind-the-wheel phase 26 of the training. The curriculum 22 and simulation presented and performed to this point serve as a solid foundation for the student to proceed safely to this segment. Thus, the novice driver has been provided with the situational awareness of safe driving that an ordinary driver with years of experience has only achieved through trial and error. Experienced drivers may also benefit from this invention, albeit with a curriculum suitable for their level.

Although the invention has been described in terms of particular embodiments in an application, one of ordinary skill in the art, in light of the teachings herein, can generate additional embodiments and modifications without departing from the spirit of, or exceeding the scope of, the claimed invention. Nothing in the above description is meant to limit the present invention to any specific subject matter, materials, geometry, or orientation of elements. Many part/orientation substitutions are contemplated within the scope of the present invention and will be apparent to those skilled in the art. Accordingly, it is understood that the drawings, descriptions and examples herein are proffered only to facilitate comprehension of the invention and should not be construed to limit the scope thereof

What is claimed is:

1. A method of training drivers comprising the steps of:
providing an environment within which said drivers may develop operational awareness;
providing an environment within which said drivers may develop tactical awareness; and
providing an environment within which said drivers may develop strategic awareness.

2. The method of claim 1, wherein one or more of said environments is provided by a driving simulator.

3. The method of claim 1, wherein one or more of said environments is provided by computer-based training.

4. The method of claim 2, wherein the driving simulator records data relating to the driver's performance.

5. The method of claim 4, wherein the data comprises lane position.

6. The method of claim 4, wherein the data comprises speed management.

7. The method of claim 4, wherein the data comprises space management.

8. The method of claim 4, wherein the data reflects the path of the vehicle.

9. The method of claim 4, further comprising the step of reviewing the data with the driver.

10. The method of claim 2, further comprising the step of assigning a score to the driver indicative of the driver's performance.

11. A system for training drivers comprising techniques for developing the operational awareness of said drivers;
techniques for developing the tactical awareness of said drivers; and
techniques for developing the strategic awareness of said drivers.

12. The system of claim 11, wherein said techniques for developing the operational awareness of said drivers comprise a driving simulator.

13. The system of claim 11, wherein said techniques for developing the tactical awareness of said drivers comprise a driving simulator.

14. The system of claim 11, wherein said techniques for developing the strategic awareness of said drivers comprise a driving simulator.
